(19) United States
(12) Patent Application Publication
(10) Pub. No.: US 2007/0124112 A1
(43) Pub. Date: May 31, 2007

(54) Method and computer program for determining performance of a computer system

(76) Inventor: Bernhard Weyermann, Hochstadt (DE)

Correspondence Address: SCHIFF HARDIN, LLP;PATENT DEPARTMENT, 6600 SEARS TOWER, CHICAGO, IL, 60606-6473, US

(21) Appl. No.: 11/603,486

(22) Filed: Nov. 22, 2006

(30) Foreign Application Priority Data
Nov. 25, 2005 (DE) 10 2005 056 250.7

(51) Int. Cl. G21C 17/00

(52) U.S. Cl. 702/182

(57) ABSTRACT

A method and computer system are provided for determining the performance of a computer system by determining at least one current performance value of the computer system in a current configuration. Processes being executed on the computer system during measurement of the performance value are determined. A comparison is made between the at least one current performance value and at least one reference value. In one example, the computer system includes a control computer and a medical assessment computer that are associated with at least one medical imaging system. The reference value may either be determined previously or it is determined in a method step by determining the performance value of the computer system in an original configuration.

### BACKGROUND OF THE INVENTION

1. Field of the Invention

The present invention relates generally to a method and computer program for determining the performance of a computer system.

2. Description of the Related Art

In developing computer systems and in maintenance of computer systems, it is desirable to determine the current performance of the computer system in order to check the proper functioning of the computer system. This checking of the computer system performance may apply to developing or maintaining both the entire computer system as well as to developing or maintaining a program or component installed on the computer system.

Methods are known for obtaining data that indicates the current performance of the computer system. By interpreting the performance data, such as by a person who is skilled in the art of computer systems, it is possible to determine the current performance of the computer system.

A method for determining the performance level of an application or a program in the computer system is known from U.S. Published Patent Application US 2004/0250234 A1. According to the method disclosed therein, a second applicational program is provided which executes along with the execution of the first application or program and which produces data indicating the performance level of the first application. The method also provides for documentation that indicates the method of interpretation of previously determined data and if applicable proposes an execution of a further application to determine additional information. According to one embodiment disclosed in the reference, the performance data which has been determined is displayed graphically or in table form. According to a further embodiment, the performance data is stored for example on a diskette.

In PCT International Published Patent Application WO 03/014878 A2, a method and system for monitoring an evaluation of performance of an application server in the network is provided. The system includes one or more load servers that simulate the load exerted on the application server by one or more devices requiring services. The load servers are configured to execute a specific sequence of server requests in order to evaluate the operating workflow of the application server under a specified load. While the application server is being tested in this manner, a plurality of performance measures concerning the operating workflow of the application server and of the network are measured and stored for later analysis. The analysis provides for statistically significant portions of the test data to be recognized and grouped according to possible correlations between the various test conditions and the established performance values.

U.S. Pat. No. 6,505,249 B1 discloses a method for evaluating and optimizing the continuous working performance of a computer network system that identifies the performance variables that influence the performance of the system. An initial performance test is implemented in order to determine a base value for each performance variable and for the system. All performance variables are held constant at their respective base value up to one. This floating performance variable is changed in steps. After each change, a new performance test is implemented and its results and the values of the performance variables are stored in a matrix. The floating performance variable is hard set again back to its base value and a different performance variable is changed in steps. This occurs until all of the performance variables have been utilized as the floating performance variable once and the matrix has been completed. Using this matrix, a computer system designer can adapt to the performance variables that have the most influence on the system performance.

### SUMMARY OF THE INVENTION

The present invention provides a low cost, low expenditure determination of the performance of the computer system. This performance determination is provided by a method for determining the performance of a computer system including determining the performance by determining at least one current performance value of the computer system in a current configuration and determining respective processes that are being executed on the computer system, and comparing the at least one current performance value with a respective reference value. A low cost determination of the performance of a computer system is also provided by a computer program which implements the foregoing method. Additional features and advantages of the present invention are also provided by the various embodiments presented herein.

By determining at least one current performance value and by comparing the current performance value with a corresponding reference value, it is possible to determine the current performance of a computer system in a low cost manner, and also without requiring special technical knowledge. In particular, even the end user of the computer system can check the proper functioning of the computer system. Similarly, a determination of the current performance of the computer system is simplified for the service technician.

### BRIEF DESCRIPTION OF THE DRAWINGS

FIG. 1 is a workflow diagram illustrating a method for determining the performance of the computer system according to the principles of the present invention; and

FIG. 2 is a schematic representation of a computer system with a control computer and a diagnosis or medical assessment computer connected to a magnetic resonance tomography apparatus, the control computer and the medical assessment computer being connected via a network to an internal storage system and a maintenance computer.

### DETAILED DESCRIPTION OF THE PREFERRED EMBODIMENTS

The present invention generally provides a method for determining the performance of a computer system. The computer system can be either a single computer or a plurality of computers connected to one another via a network. The determination of performance of the computer system can measure either the computer system as a whole or may only apply to one part of the computer system or to one application running on the computer system. It is also foreseeable that the performance determination may measure the performance of a collection or suite of applications. It is possible by determining the performance of the computer system to improve the configuration of the computer system. For example, the configuration of the computer system may include the installed applications and their respective dependency among one another or settings for one or more of the installed applications. The configuration also may include the network configuration of the computers or the hardware utilized or various other computer system features and parameters.

In a preferred embodiment, the present method is applied to a computer system that is associated with a medical imaging system; one example of which is an x-ray apparatus and another example of such a medical imaging system is a computer tomography system. In a computer tomography system, it is of particular importance that a proper functioning of the computer system is provided to ensure the safe operation of the medical imaging system and to provide a precise and accurate finding or medical assessment based on the image acquired with the imaging system. A computer system of a medical imaging system typically includes a control computer and/or in the alternative a medical assessment or diagnostic computer. Other combinations of computers are also possible. In a computer system associated with a medical imaging system which includes a control computer and a medical assessment computer, the current performance value is preferably determined by measuring the data transfer rate between the control computer on one hand and the medical assessment computer on the other hand. The performance of the data transfer connection between the two computer systems can thereby be determined. In one embodiment, the data transfer connection is configured as a known type of network, preferably based on Ethernet technology.

In many applications, the computer system includes an internal data bank or database or is connected to an external data bank or database. In this case, a current performance value is determined with regard to the data transfer between the computer system on one hand and the data bank on the other hand, which permits the proper functioning of the data transfer between the computer system and the external data bank to be checked. Since a computer that is associated with a medical imaging system is frequently connected via a data transfer connection with a data bank such as a data bank in the form of a radiographic imaging system (RIS) or a picture archiving and communication system (PACS), the performance of such systems can be determined with this embodiment. Of course, the data storage systems may be provided.

According to a further embodiment, the method for determining the performance of the computer system may be remotely controlled via an external network access to the computer system. The method may be initiated by remote control, and may operate automatically or by step-by-step control or by remote control of only some steps. It is thus possible to provide for low cost remote maintenance of the computer system. The remote control can, for example, be operated by a service technician is who is remote from the computer system. The service technician can thereby check for the proper functioning of the computer system and, if applicable, be able to detect an error in the computer system using the determination of the at least one current performance value without having to seek out and physically visit the computer system itself. Using the respective current performance value, the service technician obtains indications as to the cause that is the basis of the detected error. In the event that corresponding arrangements have been made, it is possible for the service technician to change the current configuration of the computer system to remedy the error. Alternatively, it is conceivable that the service technician may remotely communicate instructions to the end user of the computer system or to service personnel on site which can enable the end user or service personnel to correct the error using the instructions. As a further improvement in the remote control method, it is envisioned that a remote update of the computer system may be implemented.

The at least one reference value is defined before the determination of the current performance value in a particularly simple manner. The reference value corresponds in one example to a typical performance value to be expected from the computer system, or to a minimal performance value which should be expected in the operation of the computer. The expected value is a predetermined value for the computer system. By comparing the at least one current performance value with an expected reference value, it is possible in a simple manner to establish whether the performance of the computer system deviates from the expected performance or whether the computer system is operating below the minimum performance value.

According to a further embodiment, it is provided that the at least one reference value is in the form of at least one performance value of the computer system that is measured on the original configuration of the computer. The computer system is tested for the reference value and is later tested for the current performance value. Testing for the reference value is determined in a method step that precedes the testing for the current performance value. The at least one reference value of the original configuration of the computer system is determined when the computer is new or is newly configured and the at least one current performance value is determined in a current configuration of the computer system is determined. It is particularly simple to compare the performance of the current configuration with the performance of the original configuration using the values. It is thereby possible to establish the extent of variation in the performance of the computer system. The determination of the reference value may be performed by testing the original configuration of the computer system as it is configured in its delivery state or in the initial installation state of the computer system. It is also contemplated that a reference value is obtained based on the state of the computer system after installation of an update, such as an update to the operating system or an update to some application.

The at least one current performance value and the respective reference value are compared to determine if there is a deviation between these two values. When a deviation exists, the deviation is displayed in a manner so that it is perceived, for example, by the end user or by the service technician. The display may be on a computer screen or other display. In one embodiment, the deviation between the values is only displayed when it exceeds a predetermined threshold. It is also contemplated that a deviation in the values above the threshold is displayed in a different manner than a deviation below the threshold. The threshold may correspond to a deviation that endangers the proper functioning of the computer system. For example, it is possible to establish an overall percentile deviation from the reference value as the threshold or alternatively to define respective separate thresholds for each individual performance value.

According to a preferred embodiment, a single current overall performance value is derived based on at least one but more commonly a plurality of current performance values; the current overall performance value enabling the performance of the computer system to be determined in a particularly simple manner using only a single value. This single overall performance value is preferably derived using averaging, and in one example using weighted averaging, based on a plurality of performance values. The derivation of the single current overall performance value is particularly appropriate when at least two current performance values are obtained and has particular advantages when very many individual performance values have been derived.

Once the single current overall performance value is derived from the at least one current performance value, it is advantageous to compare the current overall performance value to an overall reference value that has been defined prior to the measuring of the current performance value or which is derived based on at least one original performance value.

In a further embodiment, it is provided that the comparison of the overall performance value with the overall reference value results in a determination as to any deviation in these values and if the deviation exceeds a predetermined threshold, the deviation is displayed. It is possible to establish the threshold based on the deviation of the current overall performance value of the computer system from an overall reference value and in particular to identify a deviation which would endanger the functionality of the computer system. It is also envisioned to establish an overall reference value that determines or at least suggests a desired overall performance of the computer system.

It is advantageous to store at least the current performance value and/or the current overall performance value so that a later check of the system performance can be performed. The performance values can be stored, for example, on a storage device in the computer system or on a storage device of a service computer that is connected in such a manner as to communicate data between the computer systems. In one example, a service computer can be connected remotely to the computer system and can store the performance values. It is of course envisioned to also store the original or reference performance values and/or overall reference values.

By storing a temporal sequence of the current performance values or of the respective current overall performance values, it is possible to track temporal developments in the performance of the computer system. For example, the performance values at various times during the operation of the computer system may be stored in a performance value table. By tracking the changes in the performance value over time it is possible, for example, to determine influence of changes in the configuration of the computer system on the performance of the computer system. In one embodiment, a graphical representation of the at least one performance value or of the overall performance value as it changes over time can be provided to aid in recognizing changes in the system performance in a simple way. The graphical representation is readily provided by utilizing the information in the performance value table.

In a further embodiment of the invention, it is provided that the processes which are being executed on the computer system are determined and are also stored corresponding to the determined at least one current performance value and/or the determined at least one original performance value. By tracking the respective processes being executed on the computer system with the corresponding performance value, it is possible to evaluate the performance against the background of the processes being executed. By considering the respective executed processes and comparing the at least one current performance value with the at least one respective value, it is possible to establish the influence of the executing processes on the performance of the computer system. Using this information, it is possible to alter the current configuration of the computer system in order to achieve a performance improvement.

For purposes of the present invention, a process is an application or a service program including any applications or programs running in the background.

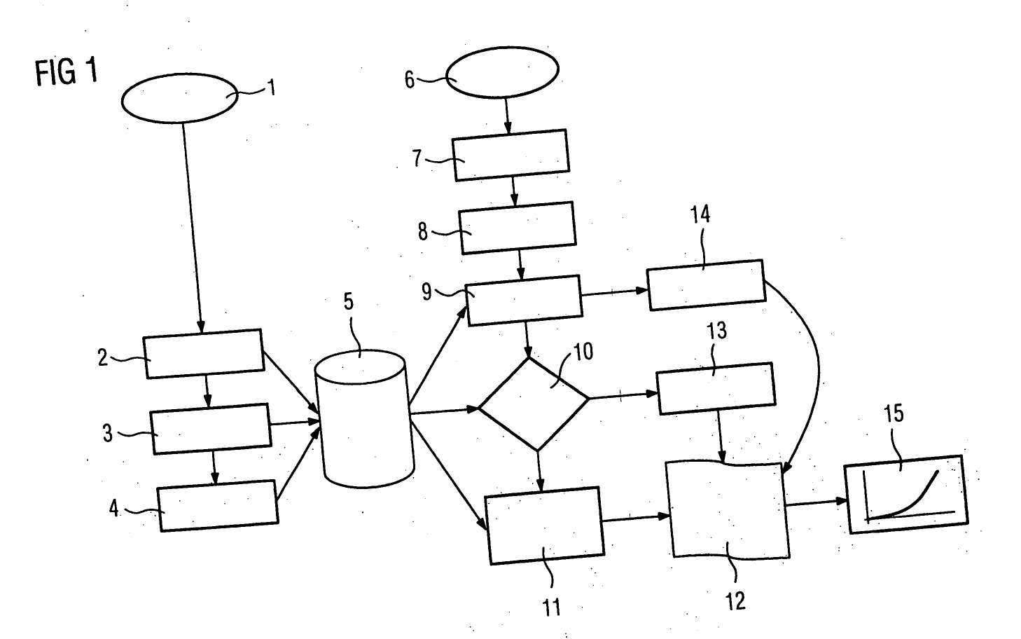

With reference to the Figures, FIG. 1 shows a workflow of the method for determining the performance of the computer system where the performance is determined by a plurality of performance values. The illustrated method is started in an initial step or start step 1 which includes determining the reference values that are associated with the performance values. In a second initial step or start step 6, a determination of respective current performance values is made.

The reference values for the performance values of the computer system are determined in an original configuration of the computer system, for example, before delivery of the computer system or after an update of the computer system or after servicing of the computer system. After the invocation of the method in the initial step 1, further method steps are performed. A determination of the reference values is made in step 2, after which an overall reference value is derived from the reference values using arithmetic averaging in step 3. In step 4, the processes which are active on the computer system are determined in conjunction with the reference values. The determined reference values, the overall reference value, and the processes which are running on the computer system are stored in a storage device 5 that is associated with the computer system. In one embodiment, the steps 1 through 4 as well as the storage step 5 are implemented prior to delivery of the computer system to an end user or customer. These steps may also be performed after delivery, such as after setup by a service technician or user.

The determination of the performance of the computer system based on the current performance values is started with the initial step or start step 6. The following steps 7 through 9 are analogous to the steps 2 through 4 as described previously. In particular, in step 7, the current performance values of the computer system are determined. In step 8, an overall performance value is derived from the current performance values using arithmetic averaging. The averaging can include weighted averaging. In step 9, the processes that are active on the computer system are determined for the performance values as measured. Once these values are determined, the acquired data of steps 7 through 9 is stored or cached for example in the storage device 5.

In step 10, the overall reference value stored in the storage device 5 is retrieved and is compared to the corresponding current overall performance value. If the comparison results in a deviation between the current overall performance value from the overall reference value that exceeds a predetermined threshold, an indication of the threshold having been exceeded is displayed and the overall current performance value as well as the individual performance values are stored in a protocol 12 with the performance value table along with a specification of a respective point in time. The storage of the values ensues in step 13 even when the deviation between the reference value and the current value does not exceed the threshold. However, if the threshold has not been exceeded, no indication of the deviation is displayed according to the preferred embodiment. In step 14, the respective processes which are active in the computer system are stored in the protocol 12 for the determined performance values. Such storage is provided regardless of whether the deviation exceeds the threshold.

In step 15, the temporal development or change in performance value over time of the current performance value and/or the overall performance value based on the protocol 12 is derived and represented graphically in order to illustrate the trend in the performance development of the computer system. The graphical representation takes into account not only the reference performance value but also the overall reference value and may include superimposing the values on one another. Further, a desired performance value may also be displayed.

The initial steps 1 and 6 for the present method may be either started manually by a user or technical person or may be invoked automatically upon delivery of the computer system as well as after every update or every service appointment for the computer system. It is also contemplated to automatically start the determination of the current performance values at planned, controlled invocations of the initial step 6. A remote control initialization of the initial step 6 via a network access may be provided in much the same way that remote maintenance is performed.

According to the foregoing, an automatic comparison made of the respective current overall performance value with the overall reference value. In addition, an individual comparison of the performance values with the respective reference performance values is also possible. Instead of making an automatic comparison, it is also possible to merely display the current values relative to the respective reference values so that the user may make their own comparison. The performance values concern various functions and system components. For example, one performance value concerns the accesses to a file system of the computer system. The file system may be for instance a fixed disk or hard disk in the computer system or other type of data storage medium. This performance value is determined by monitoring the generating, writing, reading, or deleting of files from the hard drive.

A different performance value may be obtained by measuring the performance capability of the primary memory of the computer system. To determine this performance value measurements are taken while memory blocks are generated, requested, or shifted in the primary memory. By executing a predetermined example algorithm, it is possible to determine a performance value relating to processor performance, as yet a further performance value. All cited performance values are stored in the protocol 12 in step 14 according to a preferred embodiment. The protocol 12 can be stored either locally on the computer system and/or on the remote service computer.

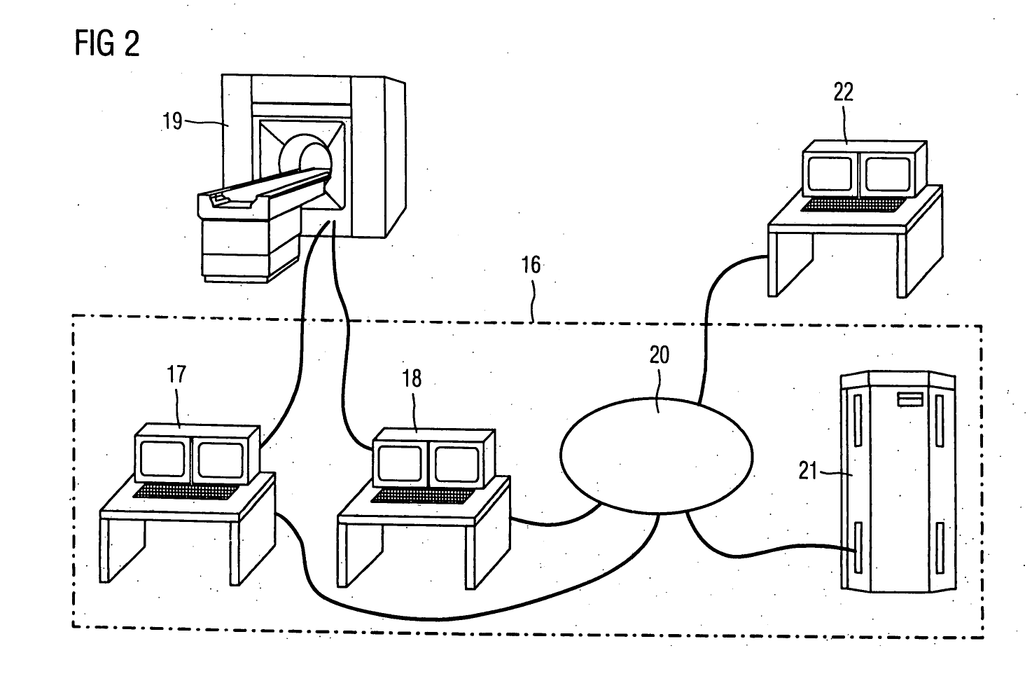

FIG. 2 shows a computer system 16 with a control computer 17 and a medical assessment computer 18 then are each associated with a medical imaging system which is in the form of a magnetic resonance apparatus (MR apparatus) 19 in the present example. A network 20 provides the communication between the control computer 17 and the medical assessment computer 18 for data transfer with an internal data bank 21 and with an external service computer 22. The internal data bank 21 may be in the form of PAC (picture archiving and communication) system. In the exemplary embodiment, the network 20 as well as the PAC system 21 belong to the computer system 16.

Instead of a magnetic resonance apparatus 19, the present computer system may alternatively or in addition be associated with an x-ray computer tomography apparatus (CT apparatus) or other diagnostic imaging system.

In the exemplary embodiment, the computer system 16 as well as the magnetic resonance apparatus 18 are both located in a hospital or other medical facility. The service computer 22 is either housed in the same hospital as the apparatus 18 and computer system 16 or is housed in a facility outside of the hospital, for example, at the facility of the manufacturer of the MR apparatus 19 or the manufacturer of the computer system 16. It is possible to connect the service computer 22 with the internal hospital network 20 via an external network, such as the Internet or other network. It is also conceivable that the PAC system 21 is provided as an external data bank that is connected with the computer 16 via the external network. In the preferred embodiment, the control computer 17 and the medical assessment computer 18 are located both in the same room, although they may instead be arranged in different rooms.

In order to obtain a medical image of a patient, the magnetic resonance apparatus 19 is controlled by the control computer 17. The images that are acquired with the magnetic resonance apparatus 19 are subsequently transferred to the medical assessment computer 18 and are displayed for generation of a medical assessment. After the medical assessment, image data is transferred via the network 20 to the PAC system 21 and is archived there. It is also possible to initially transfer the image data directly from the magnetic resonance apparatus 19 to the PAC system 21 and then to retrieve the images from the PAC system 21 to the medical assessment computer 18 via the network 20.

The control computer 17 has a data transfer connection with the medical assessment computer 18 either directly or via the network 20. In one embodiment, the performance value is determined by measuring the data transfer rate between the control computer 17 on one hand and the medical assessment computer 18 on the other hand. It is also possible to determine a performance value with regard to the data transfer rate between the computer system 16 on the one hand and the internal data bank which is made up of the PAC system 21 on the other hand. This data transfer ensues either via the control computer 17 or via the medical assessment computer 18. Means for measuring such transfer rates are well known and are not described here further. In an exemplary embodiment, the determination of the performance of the computer 16 is remotely controlled by the service computer 22 via the network 20. Portions of a computer program for implementing the method for determining the performance of the computer system 16 are located in the control computer 17, in the medical assessment computer 18 and/or in the service computer 22. For remote control by the service computer 22, the method may be initiated by the control computer 22 and permitted to run automatically or each individual method step may be individually controlled via remote control. It is also possible that only some steps are remotely controlled while others are automatic. Of course, the performance determination can be controlled on site at the computer system as well.

Thus, there is shown and described a method and system for determining the performance of a computer system where the performance is initially determined in the form of at least one current performance value of the computer system in a current configuration and processes executed on the computer system are determined, and a comparison is made of at least one of the current performance values with at least one reference value. The computer system may include a control computer and/or a medical assessment computer that are associated with at least one medical imaging system. The at least one reference value may have been previously determined or may be determined in a preceding method step where the original performance value of the computer system is tested in its original configuration.

Although other modifications and changes may be suggested by those skilled in the art, it is the intention of the inventors to embody within the patent warranted hereon all changes and modifications as reasonably and properly come within the scope of their contribution to the art.

I claim:

1. A method for determining performance of a computer system, comprising the steps of:
determining at least one current performance value of the computer system in a current configuration to determine a current performance; and
comparing the at least one current performance value with a respective reference value.

2. A method as claimed in claim 1, wherein the computer system includes at least one of a control computer and a medical assessment computer respectively associated with a medical imaging system.

3. A method as claimed in claim 2, wherein said at least one of said control computer and said medical assessment computer includes both a control computer and a medical assessment computer, and wherein said current performance value is determined by measuring a data transfer rate between said control computer and said medical assessment computer.

4. A method as claimed in claim 1, wherein said computer system includes a data bank and wherein said current performance value is determined by measuring a data transfer rate between the computer system and the data bank.

5. A method as claimed in claim 1, further comprising the step of:
remotely controlling said method for determining performance remotely via an external network access to the computer system.

6. A method as claimed in claim 1, further comprising the step of:
defining a reference value prior to said step of determining the at least one current performance value.

7. A method as claimed in claim 6, wherein said reference value is an original performance value of the computer system in an original configuration.

8. A method as claimed in claim 1, further comprising the step of:
displaying an indication that a deviation between the current performance value and the reference value exceeds the predetermined threshold.

9. A method as claimed in claim 1, further comprising the step of:
deriving an overall performance value from a plurality of current performance values.

10. A method as claimed in claim 9, wherein said overall performance value is derived from a plurality of current performance values by averaging.

11. A method as claimed claim 10, wherein said averaging is a weighted average.

12. A method as claimed in claim 9, further comprising the step of comparing a current overall performance value with an overall reference value.

13. A method as claimed in claim 12, wherein said overall reference value is defined from a plurality of original performance values.

14. A method as claimed in claim 12, wherein an indication is displayed if a deviation between the overall performance value from the overall reference value exceeds a predetermined threshold.

15. A method as claimed in claim 1, further comprising the step of:
storing at least one current performance value.

16. A method as claimed in claim 15, further comprising the step of:
providing a performance value table for a plurality of current performance values.

17. A method as claimed in claim 16, further comprising the step of:
displaying graphically a temporal development of said at least one performance value by reference to the performance value table.

18. A method as claimed in claim 1, further comprising the step of:
determining at least one original performance value for respective processes executed on the computer system, and
storing said at least one original performance value.

19. A method as claimed in claim 1, wherein said comparing step takes into account processes being executed at a time of determination of the at least one current performance value relative to processes being executed upon measurement of said at least one respective reference value.

20. A computer program stored on a computer readable medium and executable on a computer, said computer program when executed performing the steps of:
determining a performance of a computer system using at least one current performance value of the computer system in a current configuration, and
comparing the at least one current performance value with at least one corresponding reference value.
